(19) United States
(12) Patent Application Publication
(10) Pub. No.: US 2025/0298564 A1
(43) Pub. Date: Sep. 25, 2025

(54) INFORMATION PROCESSING SYSTEM, NON-TRANSITORY COMPUTER READABLE MEDIUM AND METHOD

(71) Applicant: FUJIFILM Business Innovation Corp., Tokyo (JP)

(72) Inventors: Miyu FUJII, Kanagawa (JP); Masafumi SUGAWARA, Kanagawa (JP); Jun WAKAMATSU, Kanagawa (JP)

(73) Assignee: FUJIFILM Business Innovation Corp., Tokyo (JP)

(21) Appl. No.: 18/782,791

(22) Filed: Jul. 24, 2024

(30) Foreign Application Priority Data
Mar. 22, 2024 (JP) 2024-046557

(51) Int. Cl. G06F 3/12

(52) U.S. Cl. CPC G06F 3/1273; G06F 3/1226; G06F 3/1285

(57) ABSTRACT

An information processing system includes a processor configured to: when an inquiry about a function of a manufacturing apparatus is received from a user of the manufacturing apparatus, present, to the user, a production record available on the manufacturing apparatus with respect to the function.

### CROSS-REFERENCE TO RELATED APPLICATIONS

This application is based on and claims priority under 35 USC 119 from Japanese Patent Application No. 2024-046557 filed Mar. 22, 2024.

### BACKGROUND

### (i) Technical Field

The present disclosure relates to an information processing system, a non-transitory computer readable medium and a method.

### (ii) Related Art

Japanese Unexamined Patent Application Publication No. 2015-184723 discloses a server of a document production support system. The server includes a graphical user interface (GUI), a maintenance and management unit, a case search unit and a document management unit. The GUI provides a screen on a terminal of a user. The maintenance and management unit registers a document as case information on a database (DB) in response to a user operation on the screen and manages information on an item related to a configuration of a product as a case. The case search unit searches the DB for the case information by inputting a condition including specifications of the product and prioritized point provided by a customer, extracts the case information satisfying the condition and displays search result information. The document management unit is capable of editing, as a draft document, a document of the selected case information. The prioritized point includes at least one of cost, order reception result and quality.

### SUMMARY

Aspects of non-limiting embodiments of the present disclosure relate to providing a user of a manufacturing apparatus with an information processing system that presents production records related to a function of which the user inquires.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system including a processor configured to: when an inquiry about a function of a manufacturing apparatus is received from a user of the manufacturing apparatus, present, to the user, a production record available on the manufacturing apparatus with respect to the function.

### BRIEF DESCRIPTION OF THE DRAWINGS

Exemplary embodiments of the present disclosure will be described in detail based on the following figures, wherein:

FIG. 1 illustrates a processing system of an exemplary embodiment of the disclosure;

FIG. 2 illustrates a configuration of a printer of the exemplary embodiment of the disclosure;

FIG. 3 illustrates a configuration of a server of the exemplary embodiment of the disclosure;

FIG. 4 illustrates a consent confirmation screen used when the printer of the exemplary embodiment of the disclosure asks a user whether the user consents to transmitting a printing record to the server;

FIG. 5 is a sequence diagram that illustrates how printing record data is transmitted in the processing system of the exemplary embodiment of the disclosure;

FIG. 6 is a sequence diagram that illustrates how the printing record is searched for in the processing system of the exemplary embodiment of the disclosure;

FIG. 7 is a sequence diagram that illustrates an operation procedure in the processing system of the exemplary embodiment of the disclosure from when the server receives an inquiry from the printer and to when the server replies;

FIG. 8 is a diagram that illustrates how a similar record is searched for in the processing system of the exemplary embodiment of the disclosure wherein the diagram illustrates a result of comparison of functions that are used with another user:

FIG. 9 is a diagram that illustrates how the similar record is searched for in the processing system of the exemplary embodiment of the disclosure wherein the diagram illustrates a distance to the other user;

FIG. 10 is a diagram that illustrates how the similar record is searched for in the processing system of the exemplary embodiment of the disclosure wherein the diagram illustrates a result of comparison where the functions used with the other user are weighted on a per function basis and then compared with each other;

FIG. 11 is a diagram that illustrates how the printing record of the exemplary embodiment of the disclosure is provided to the user wherein the diagram indicates a search result display screen that presents multiple printing records;

FIG. 12 is a diagram that illustrates in addition to FIG. 11 how the printing record of the exemplary embodiment of the disclosure is provided to the user wherein the diagram indicates setting items of a selected printing record and a printing record display screen displaying a preview;

FIG. 13 is a diagram that illustrates in addition to FIG. 12 how the printing record of the exemplary embodiment of the disclosure is provided to the user wherein the diagram indicates a printing record application screen that is used to perform a printing operation by applying a job in accordance with the selected printing record;

FIG. 14 illustrates a processing system according to a first modification of the exemplary embodiment of the disclosure; and

FIG. 15 illustrates a processing system according to a second modification of the exemplary embodiment of the disclosure.

### DETAILED DESCRIPTION

Exemplary embodiments of the disclosure are described with reference to the drawings. In the drawings, like or identical elements or components are designated with the same reference numerals. Dimension ratios of the drawings are exaggerated in practice for convenience of explanation and may thus be different from practical dimension ratios.

### Exemplary Embodiments

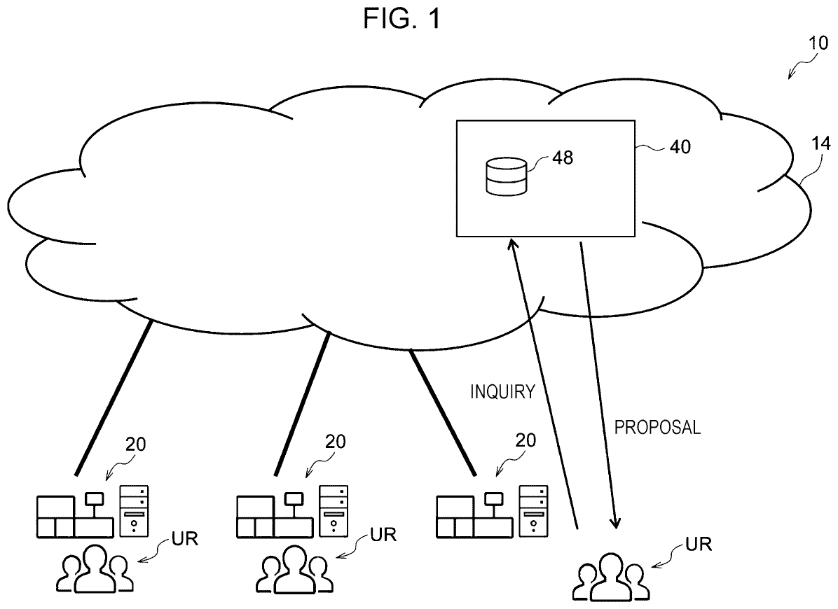

FIG. 1 illustrates a processing system 10 of an exemplary embodiment of the disclosure. The information processing system 10 includes multiple printers 20 connected to a network 14 and a server 40 connected to the network 14. According to the exemplary embodiment, users UR respectively using the printers 20 may include persons who are unknown to each other. The printer 20 in FIG. 1 is an example of a “manufacturing apparatus” in the exemplary embodiment.

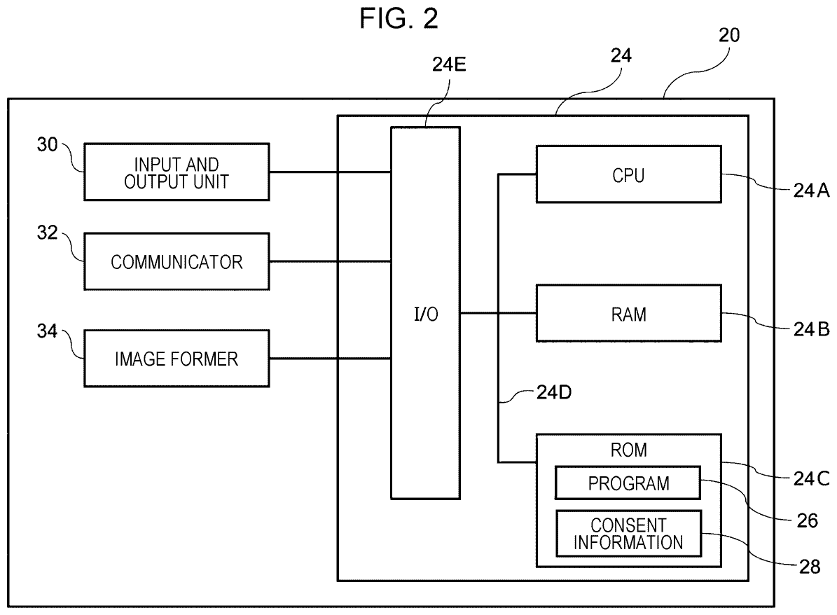

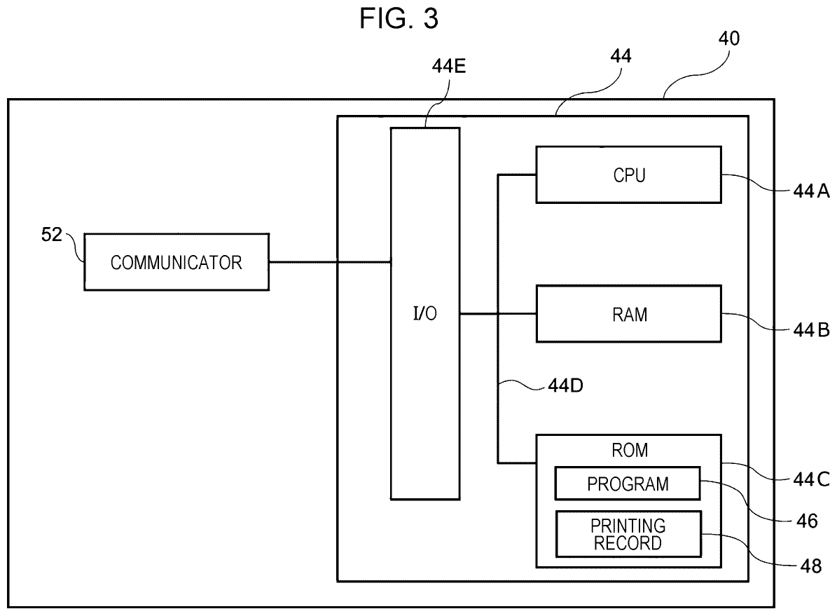

Configurations of the elements in the information processing system 10 of the exemplary embodiment are described with reference to FIGS. 2 and 3.

### Printer 20

Referring to FIG. 2, the printer 20 includes a controller 24, communicator 32, input and output unit 30 and image former 34. As illustrated in FIG. 2, the controller 24 includes a central processing unit (CPU) 24A, random-access memory (RAM) 24B, read-only memory (ROM) 24C and input-output interface 24E. These elements are interconnected to each other via a control bus 24D.

The CPU24A serving as a central processing unit executes a variety of programs and controls each section of the printer 20. The RAM 24B operating as a working area and temporarily stores a program 26 or data. The ROM 24C stores a variety of data including consent information 28 and a program 26 that performs an operation of an image forming apparatus.

The CPU 24A in the controller 24 reads from the ROM 24C a variety of programs including the program 26 and then executes the program 26 using the RAM 24B as a working area. By executing the program 26, the CPU 24A implements a variety of functions controlling each section of the printer 20.

In response to a reception of an instruction of the user UR, the input and output unit 30 notifies the CPU 24A in the controller 24 of the received instruction and presents information to the user UR in response to an instruction from the CPU 24A. The input and output unit 30 may be a device, such as a touch panel, and receive inputs and perform displaying.

The communicator 32 is configured to communicate with another device via the network 14. Specifically, the communicator 32 communicates with the other device using a wired line, wireless line, the Internet, Intranet and/or a communication medium, such as a public network including a telephone line.

The image former 34 has a configuration (not illustrated) including an image forming unit that forms an image on recording paper, color tone adjuster that adjusts a color tone of an image to be formed, container housing the recording paper, transporter that transports the recording paper and other elements. The image former 34, controlled by the controller 24, forms an image on the recording paper. Although the image former 34 may have any configuration in the exemplary embodiment, any value may be set to any of setting items on the controller 24 using software.

According to the exemplary embodiment, the controller 24 has a set value that is directly manually set by the user UR. Specifically, with respect to a preparation of a printing operation on the image former 3 with the preparation including setting paper quality and type of color shade of the recording paper, a result that is set to an item manually prepared by the user UR corresponds to a set value at a manually set setting item.

The printer 20 of the exemplary embodiment may determine an image to be formed on the recording paper when the user UR sets each of the setting value to be any value. In other words, the printer 20 produces a printed material by performing a print job in accordance with a set value at a setting item on software and a set value at a setting item manually set by the user UR. Specifically, the user UR uses a function of the printer 20 by setting the value at the setting item settable on the printer 20 to be any value.

Each printer 20 of the exemplary embodiment is used by the user UR who records an image on the recording paper. In other words, the printer 20 of the exemplary embodiment is an example of the manufacturing apparatus of each user UR.

Each printer 20 illustrated in FIG. 1 is configured as illustrated in FIG. 2 but is not limited to any particular model number or any element number. In other words, each printer 20 illustrated in FIG. 1 may have a different function.

### Server 40

As illustrated in FIG. 3, the server 40 includes a controller 44 and communicator 52. As illustrated in FIG. 3, the controller 44 includes a CPU 44A, RAM 44B, ROM 44C and input-output (I/O) interface 44E. These elements are interconnected via a control bus 44D.

The CPU 44A is a central processing unit serving as an example of a processor and executes a variety of programs and controls each element in the server 40. The RAM 44B temporarily stores a program 46 or data. The ROM 44C stores the program 46 serving as an example of a “program” in the disclosure and printing record data 48 serving as an example of “production records” in the disclosure.

The CPU 44A in the controller 44 reads from the ROM 44C the variety of programs including the program 46 and executes the read program 46 using the RAM 44B as a working area. By executing the program 46, the CPU 44A implements a variety of functions that control the elements of the server 40.

As illustrated in FIG. 1, the printing record data 48 includes set values in print jobs performed by the printers 20 connected via the network 14 and a variety of set values including a set value on the image former 34 of the printer 20 having performed a print job.

The communicator 52 is configured to communicate with another device via the network 14. Specifically, the communicator 52 communicates with the other device using a wired line, wireless line, the Internet, Intranet and/or a communication medium, such as a public network including a telephone line.

As described above, each printer 20 in the exemplary embodiment forms on a recording paper sheet a set image by controlling multiple elements in response to an instruction from the controller 24. The multi-function printer 20 typically has a considerable number of functions having values that are settable and any specific operation function may go unnoticed by the user UR.

In the information processing system 10 of the exemplary embodiment, the user UR of the printer 20 (the printer 20 on the right-hand side in FIG. 1) inquires the server 40 of the function of the printer 20 via the network 14 as illustrated in FIG. 1. In response to the inquiry, the server 40 presents to the user UR having inquired the function of the printer 20 by referencing the printing record data 48.

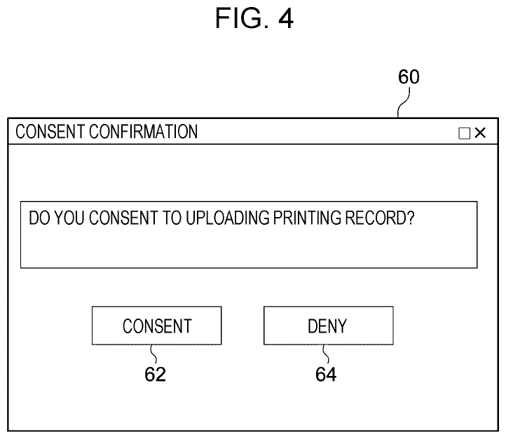

When the printer 20 in the information processing system 10 of the exemplary embodiment starts up, a consent confirmation screen 60 is displayed on the printer 20 as illustrated in FIG. 4. The consent confirmation screen 60 is used to ask the user UR of the printer 20 whether the user UR consents to transmitting the printing record to the server 40. If the user UR selects on the consent confirmation screen 60 a consent button 62 that registers a consent to transmitting the printing record to the server 40, the consent is registered in the consent information 28 of the ROM 24C. If the user UR selects on the consent confirmation screen 60 a deny button 64 that registers a denial of transmitting the printing record to the server 40, the denial is registered in the consent information 28 of the ROM 24C. The consent confirmation screen 60 is an example of a “screen causing the user to consent to providing the printing record via the network 14” of the exemplary embodiment.

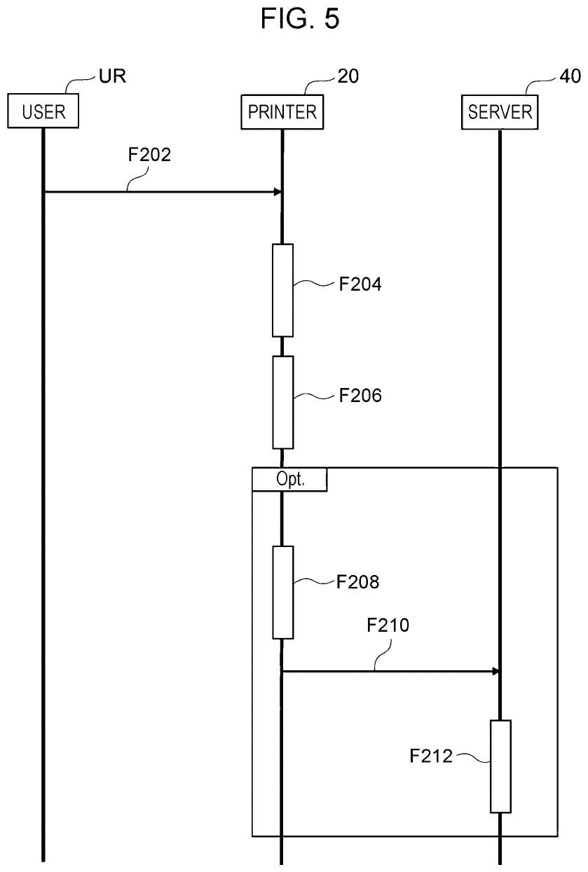

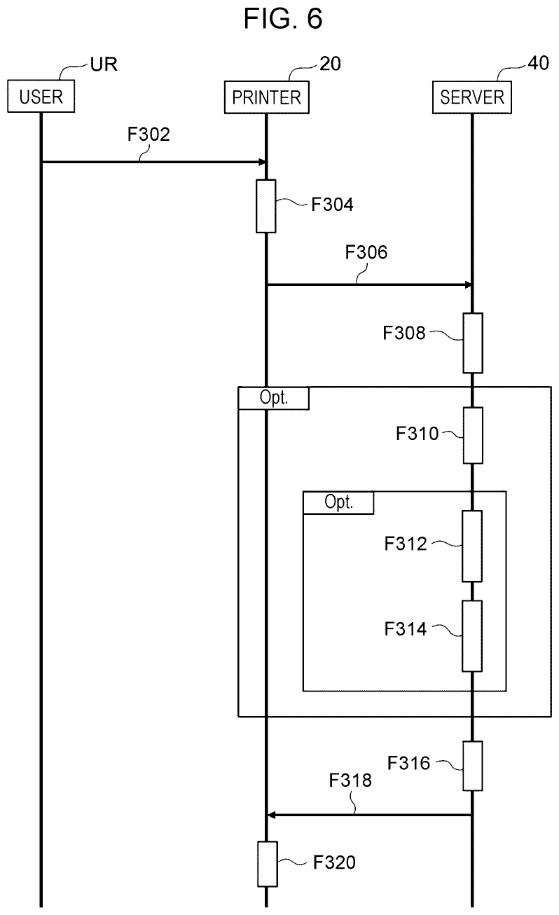

The operation procedures performed by the information processing system 10 of the exemplary embodiment are described with reference to FIGS. 5 through 10. The operation procedures include an operation procedure that is performed by the user UR to record the printing record in the printing record data 48 and an operation procedure that receives a presentation of a function when the user UR inquires the server 40 of the function. It is assumed that the settable values are set by the user UR on the printer 20 although such a setting is not illustrated in FIGS. 5 and 6.

### Operation Procedure of Recording Printing Record Data 48

FIG. 5 is a sequence diagram that illustrates an operation procedure in which the printing record data 48 is recoded when the user UR transmits the printing record to the server 40.

In event F202, the user UR inputs a print job to the printer 20. Specifically, the user UR inputs the print job by operating a personal computer (PC) or the input and output unit 30 in the printer 20.

In event F204, the printer 20 performs the print job input in event F202. Specifically, the CPU 24A in the printer 20 performs the print job input in event F202 in accordance with the set value.

In event F206, the CPU 24A in the printer 20 references the consent information 28 recorded on the ROM 24C in the printer 20 and determines the permission of the transmission of print setting. Specifically, the CPU 24A determines whether the consent is set in the consent information 28. If the consent is set in the consent information 28, the CPU 24A performs an operation in event F208.

In event F208, the CPU 24A in the printer 20 collects setting information on the printing record of printing performed in event F204. Specifically, the CPU 24A produces collected data by collecting setting information, included in the print job, on an image forming unit, recording paper sheet and transport unit, information on the type of a printed material produced in the print job, and a frequency of use of a function used on the printer 20. According to the exemplary embodiment, the collected data does not include the name of the user UR having performed the print job and image data printed in the print job.

In event F210, the CPU 24A in the printer 20 transmits the collected data to the server 40 by controlling the communicator 32.

In event F212, the CPU 44A in the server 40 determines the set value of the printer 20 in response to the collected data transmitted from the printer 20. Specifically, in event F212, the CPU 44A in the server 40 references, as the set value included in the print job and the setting information on the printer 20, the type of the printed material in the collected data transmitted in event F210. The CPU 44A in the server 40 records the referenced set value as the printing record data 48.

### Operation Procedure to Receive Presentation of Function of Printer 20

FIG. 6 is a sequence diagram of an operation procedure in which a function available on the printer 20 and included in the printing record data 48 is presented when the user UR inquires the server 40 of the function of the printer 20.

In event F302, the user UR inputs to the input and output unit 30 in the printer 20 a keyword according to which the server 40 is inquired of the function. Specifically, the user UR inputs the keyword of the inquiry by operating the input and output unit 30 in the printer 20.

In event F304, the CPU 24A in the printer 20 produces inquiry data attached to the keyword. Specifically, the CPU 24A produces the inquiry data attached to the keyword by referencing the setting information on the image forming unit, color toner adjuster, recording paper, transporter and the like, a log of use of the functions of the printer 20 and the consent information 28 recorded on the ROM 24C in the printer 20.

In event F306, the CPU 24A in the printer 20 transmits the inquiry data to the server 40 by controlling the communicator 32.

In event F308, the CPU 44A in the server 40 performs a consent/denial determination in response to the inquiry data transmitted from the printer 20. Specifically, the CPU 44A in the server 40 references a value of the consent information 28 included in the inquiry data transmitted in event F306. The CPU 44A in the server 40 performs an operation in event F310 if the consent is set to the value of the consent information 28 included in the inquiry data.

In response to a function of the printer 20 included in the inquiry data, the CPU 44A in the server 40 searches for the printing record of the printer 20 having the function in event F310. Specifically, the CPU 44A in the server 40 extracts from the printing record data 48 the printing record applicable on the printer 20 that has transmitted the inquiry data in event F306. If at least one of the printing record is hit in event F310, the CPU 44A in the server 40 performs an operation in event F312.

In event F312, the CPU 44A in the server 40 calculates a distance of the printing record hit in event F310. The distance indicates a similarity to the printer 20 having transmitting the inquiry data. Specifically, the CPU 44A in the server 40 calculates the distance indicating “more similarity” from among the printing record hit in event F310. The calculation method of the distance between the printing record and the printer 20 is described below.

In event F314, the CPU 44A in the server 40 rearranges the order of the hit printing record in accordance with the distance calculated in event F312.

In event F316, the CPU 44A in the server 40 produces the search result data that is to be transmitted to the printer 20. Specifically, when the denial determination is performed in event F308, the CPU 44A in the server 40 produces, as the search result data, a result indicating that the inquired function is not available. If the corresponding printing record is not hit in event F310, the CPU 44A in the server 40 produces the search result data as a result indicating that the corresponding printing record is not hit. If the operations in events F312 and F314 are performed, the CPU 44A in the server 40 produces the search result data that is based on the rearranged order of the printing record.

In event F318, the CPU 44A in the server 40 transmits the search result data to the printer 20. Specifically, the CPU 44A in the server 40 replies to the received inquiry from the printer 20 by transmitting to the printer 20 the search result data produced in event F316.

In event F320, the CPU 24A in the printer 20 displays on the input and output unit 30 the search result data transmitted from the server 40 in event F318. In other words, the CPU 24A in the printer 20 displays to the user UR the search result data received in event F318, thereby presenting to the user UR the function of the printer 20 which the user UR has inquired.

The denial determination is performed in event F308 when the consent is not set to the value of the consent information 28, namely, when the denial is set to the value of the consent information 28. In other words, the denial set to the value of the consent information 28 is the case in which a denial determination is performed in event F206 and the user UR denies providing the printing record. In other words, if the user UR consents to transmitting the printing record to the server 40 in the information processing system 10 of the exemplary embodiment, the user UR may inquire the printer 20 of the function thereof.

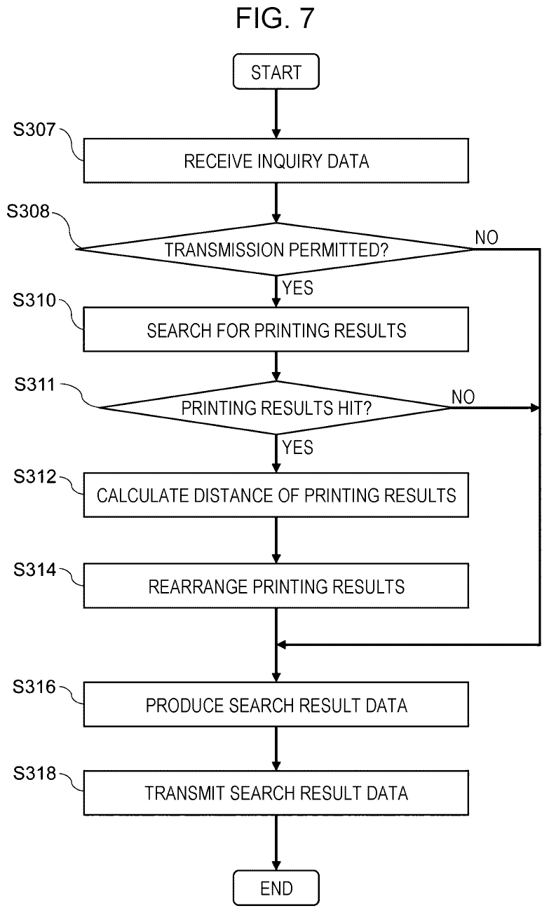

A specific operation procedure of the CPU 44A in the server 40 in a process that the function of the printer 20 is presented is described with reference to FIG. 7. FIG. 7 is a sequence diagram that illustrates a response operation from when the server 40 receives an inquiry from the printer 20 and then replies to the printer 20.

In step S307 in FIG. 7, the CPU 24A in the printer 20 waits on standby until the inquiry data is received and when the inquiry data is transmitted from the printer 20 in step S306, the CPU 24A receives the inquiry data. The CPU 24A proceeds to step S308.

The CPU 44A in the server 40 determines in step S308 whether the transmission of the print setting of the printer 20 is permitted. Step S308 corresponds to event F308 in FIG. 6. If the yes path is followed in step S308, the CPU 44A in the server 40 proceeds to step S310. On the other hand, if the no path is followed in step S308, the CPU 44A in the server 40 proceeds to step S316.

In step S310, the CPU 44A in the server 40 references and searches the printing record data 48 for the printing record responsive to the inquiry data received in step S310. Step S310 thus corresponds to event F310 in FIG. 6. The CPU 24A then proceeds to step S311.

In step S311, the CPU 44A in the server 40 determines whether the result of the search in step S310 leads to at least of one hit of printing records. If the yes path is followed in step S311, the CPU 44A in the server 40 proceeds to step S312. If the no path is followed in step S311, the CPU 44A in the server 40 proceeds to step S316.

In step S312, the CPU 44A in the server 40 calculates the distance of the printing record hit in step S310. The distance indicates a similarity to the printer 20 having transmitted the inquiry data. Step S312 thus corresponds to event F312 in FIG. 6. The CPU 44A in the server 40 then proceeds to step S314.

In step S314, the CPU 44A in the server 40 rearranges the order of the printing record hit in accordance with the distance calculated in step S312. Step S314 thus corresponds to event F314 in FIG. 6. The CPU 44A in the server 40 proceeds to step S316.

In step S316, the CPU 44A in the server 40 produces the search result data. Specifically, if the corresponding printing record is not hit in step S310, the CPU 44A produces as the search result data a result including an indication that the corresponding printing record is not hit. If the operations in steps S312 and S314 are performed, the CPU 44A in the server 40 produces the search result data that is based on the rearranged order of the printing record. Specifically, step S316 corresponds to event F316 in FIG. 6. The CPU 44A in the server 40 proceeds to step S318.

In step S318, the CPU 44A in the server 40 transmits the search result data to the printer 20. Specifically, the CPU 44A in the server 40 transmits to the printer 20 the search result data produced in step S316. Step S318 thus corresponds to event F316 in FIG. 6. The CPU 44A in the server 40 completes the response operation thereof.

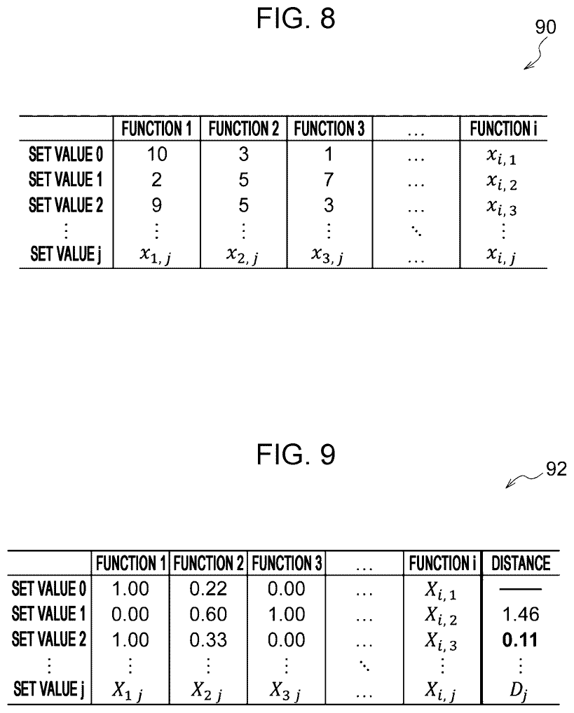

The operation procedure of calculating the distance performed by the CPU 44A in the server 40 of the exemplary embodiment is described below with reference to FIGS. 8 through 10. First Example of Distance Calculation Method and Rearranging Method

FIGS. 8 and 9 illustrate a first example of a method of calculating distance in event F312 in the exemplary embodiment. The CPU 44A in the server 40 retrieves the printing record data 48 from the ROM 24C in event F312 and produces, concerning the set values included in the printing record data 48, a usage function comparison table 90 including a set value of the printer 20 having made the inquiry.

For example, in the usage function comparison table 90 illustrated in FIG. 8, the CPU 24A lists “set value 0” as a set value of the printer 20 having made the inquiry at the first row and set values included in the printing record acquired in event F310 (set value 1, set value 2, set value 3, . . . , set value j, wherein j is a positive integer) at the second and subsequent rows.

Each of the columns of the usage function comparison table 90 in FIG. 8 lists a value of a frequency of use of a function i of the printer 20 having made the inquiry (function 1, function 2, function 3, . . . , function i, wherein i is a positive integer). The value indicating the frequency of use may be expressed in any format. For example, the value indicating the frequency of use of the function of each printer 20 may be a ratio of use of the function or a count at which the function is used.

As illustrated in FIG. 9, the CPU 24A scales within a range from 0 to 1 each value listed in the usage function comparison table 90 illustrated in FIG. 8 and then calculates distance, thereby producing the distance comparison result table 92.

Specifically, the CPU 24A scales within a range from 0 to 1 each value listed in the usage function comparison table 90 in accordance with equation (1).

$${X}_{i , j} = \frac{{x}_{i , j} - Min ( {x}_{j} )}{Max ( {x}_{j} ) - Min ( {x}_{j} )} \qquad ( 1 )$$

In equation (1), x_{i,j} is a value of each function prior to scaling (pre-scaling set value) and x_{i,j} is a value of the function subsequent to scaling (post-scaling set value). Min(xⱼ) is a function representing a minimum value from among the pre-scaling set value and Max(xⱼ) is a function representing a maximum value from among the pre-scaling set values.

The CPU 24A calculates the distance of each of the post-scaling set values to the set value (set value 0) of the printer 20 having made the inquiry. The calculated distance may be of any type and, for example, Euclidean distance expressed by equation (2) may be used.

$${D}_{j} = \sqrt{{\sum }_{k = 1}^{i} {( {X}_{0 , j} - {X}_{k , j} )}^{2}} \qquad ( 2 )$$

Dⱼ in equation (2) expresses a distance to the set value “set value 0” of the printer 20 having made the inquiry.

The CPU 24A calculates the distance in the operation procedure in FIG. 9 in event F312. The CPU 24A rearranges the set values in the order of shorter to longer calculated distance in event F314.

### Second Example of Distance Calculation Method and Rearranging Method

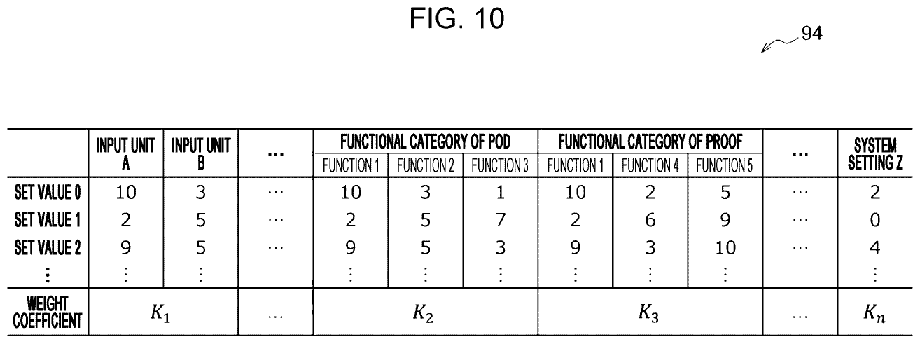

FIG. 10 illustrates a second example of a method of calculating distance in event F312 in the exemplary embodiment. The CPU 44A in the server 40 retrieves the printing record data 48 from the ROM 24C in event F312 and produces, concerning the set values included in the printing record data 48, a weighted usage function comparison table 94 including a set value of the printer 20 having made the inquiry.

As the usage function comparison table 90 illustrated in FIG. 8, the weighted usage function comparison table 94 illustrated in FIG. 10 lists a value indicating a frequency of use of each function of the printer 20. A weight coefficient of each function is also listed in the weighted usage function comparison table 94 illustrated in FIG. 10. The weight coefficient may be set in any manner and, for example, the weight coefficient is set on a per category basis of used functions.

In the calculation method illustrated in FIG. 10, the value of a frequency of use of a function covering multiple categories is calculated on a per category basis. Referring to FIG. 10, the function 1 is listed in both a “functional category related to print on demand (POD)” and a “functional category related to proof” and a weight coefficient is set on each functional category. According to the exemplary embodiment, the weight coefficient is an example of a weight based on the classification of functions.

As in the first example, the calculation method performs the scaling operation and distance calculation. The distance calculation is not limited to the Euclidean distance described with reference to the first and second examples and may be Manhattan distance or Maharanobis distance.

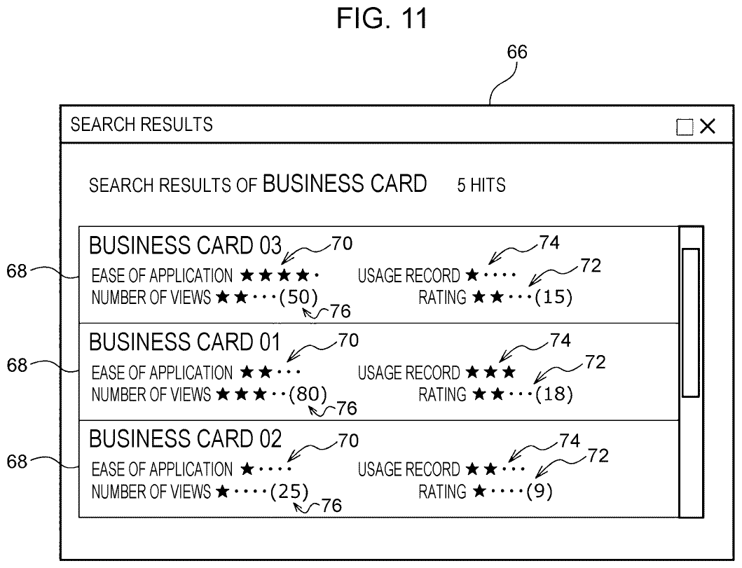

How the CPU 24A in the printer 20 of the exemplary embodiment presents the printing record to the user UR in event F320 is described with reference to FIGS. 11 through 13.

### Presentation of Printing Record

FIG. 11 illustrates a search result display screen 66 that is obtained when the CPU 24A in the printer 20 extracts multiple printing records and displays the search result of the printing records on the input and output unit 30 in event F310. Referring to FIG. 11, the search result display screen 66 includes printing record objects 68 indicating multiple printing records, an ease of application display icon 70 indicating the “ease of application” of each printing record and a rating display icon 72 indicating the “rating” of each printing record. The printing record object 68 includes an operation result display icon 74 indicating a “count at which each printing record is applied and used” and a view count display icon 76 indicating a “count at which each printing record is viewed.”

Referring to FIG. 11, the ease of application display icon 70 displays the number of star icons that indicate how easy the user UR using the printer 20 having made the enquiry applies each printing record on the printer 20. The ease of application on the printer 20 is calculated in accordance with the distance to the printer 20 calculated in event F312. For example, the number of star icons is a reciprocal of the distance to the printer 20 in the set value of each printing record.

Referring to FIG. 11, the printing record having a larger number of star icons displayed as the ease of application display icon is placed higher in position on the search result display screen 66. In other words, the printing record object 68 having a shorter distance to the printer 20 at the set value of each printing record is displayed higher in position on the search result display screen 66.

The search result display screen 66 in FIG. 11 is an example in which the CPU 24A presents each of the printing records in the order of similarity to the setting condition of the printer 20 in the exemplary embodiment. In other words, the search result display screen 66 in FIG. 11 is an example in which the CPU 24A determines the order of similarity of each of the printing records in accordance with the frequency of use of the printer 20.

The rating display icon 72 is represented by the number of star icons by referring to each printing record. The number of star icons indicates a count at which printing is performed on the printer 20 for a predetermined period of time before the inquiry issued by the printer 20. Specifically, the number of star icons in the rating display icon 72 is larger as another user UR has applied more the printing record. Each number in parentheses in the rating display icon 72 represents a count at which the other user UR has applied the printing record. Specifically, the rating display icon 72 is an example of a “count at which an operation related to the production records is performed” in the exemplary embodiment.

The operation result display icon 74 displays a count into which the number of applications of the printing record applied by the other users is accumulated. In other words, regardless of a trend at the time of the inquiry made by the printer 20, the operation result display icon 74 displays the count of the past applications of the printing record performed by the other users UR.

The view count display icon 76 is represented by the number of star icons. The number of star icons represents a count at which the other user UR views each printing record for a predetermined period of time before the inquiry performed by the printer 20. Specifically, the view count display icon 76 has a larger number of star icons as the other user UR has viewed more each printing record. Each number in parentheses in the view count display icon 76 displays the count at which the other user UR has viewed the printing record.

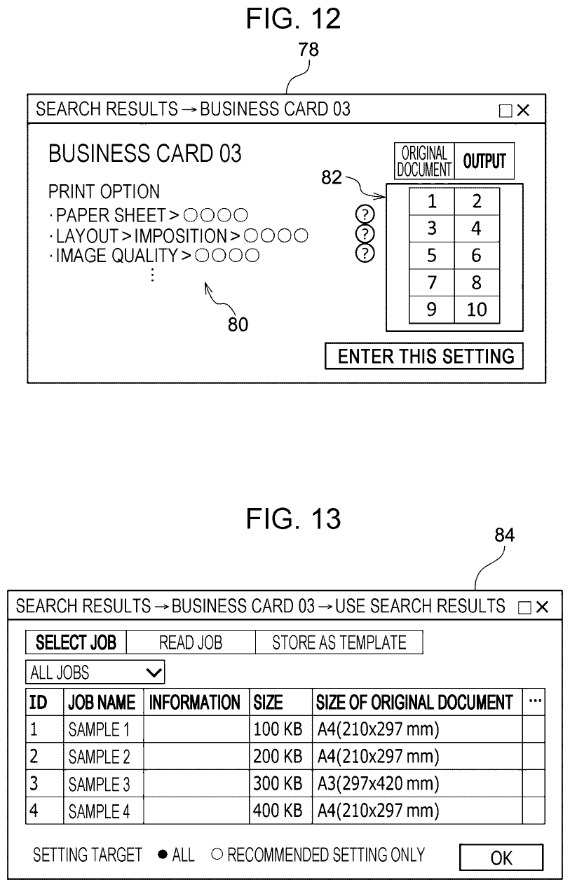

When the user UR selects one of the printing record objects 68, the CPU 24A in the printer 20 displays the printing record display screen 78 illustrated in FIG. 12.

Referring to FIG. 12, the printing record display screen 78 displays set values 80 of setting items recorded in the printing record and a preview 82 when the printing record is applied. The printing record display screen 78 also displays an enter button that determines the application of the printing record as illustrated in FIG. 12.

The preview 82 displays an image that is to be printed when the printing record of a print job is applied. The print job is registered in sample data prepared by the server 40 or is beforehand registered on the printer 20 by the user UR. The user UR determines whether to apply the selected printing record by verifying the image displayed on the preview 82.

When the user UR determines the application of the printing record and selects the enter button, the CPU 24A in the printer 20 displays a printing record application screen 84 illustrated in FIG. 13.

The printing record application screen 84 displays as illustrated in FIG. 13 a print job beforehand registered on the printer 20 by the user UR. The user UR performs a printing operation by selecting a print job that performs the printing operation using the printing record.

If the user UR displays the printing record display screen 78 illustrated in FIG. 12, the CPU 24A in the printer 20 transmits to the server 40 data indicating that the printing record has been viewed, though this operation is not illustrated. If the user UR performs the printing operation with the printing record illustrated in FIG. 13 applied, the CPU 24A in the printer 20 transmits to the server 40 data indicating that the printing operation has been performed with the printing record applied.

The information processing system 10 and program 46 of the exemplary embodiment operate as described below and thus may provide the effects described below.

### Operation and Effects

The information processing system 10 of the exemplary embodiment presents to the user UR the printing record about the function available on the printer 20 when the CPU 44A receives from the user UR of the printer 20 an inquiry about the function of the printer 20. The information processing system 10 of the exemplary embodiment may present to the user UR of the printer 20 the printing record of the function available on the printer 20 responsive to the inquiry from the user UR.

The information processing system 10 of the exemplary embodiment presents the printing records in the order of similarity to the setting condition of the printer 20 used by the user UR. The information processing system 10 of the exemplary embodiment may thus increase user friendliness in comparison with the case in which the printing records are randomly presented.

The information processing system 10 of the exemplary embodiment determines the order of similarity of the printing records in accordance with the frequency of use of the function of the printer 20. The information processing system 10 of the exemplary embodiment may thus present the printing records to the user UR in the order of high to low possibility at which the printing record is applied by the user UR.

The information processing system 10 of the exemplary embodiment weights the frequency of use in accordance with the classification of the function of the printer 20. The information processing system 10 of the exemplary embodiment may present the printing record which is more likely to be applied by the user UR in comparison with the case in which the weights of the classifications are equal to each other.

In the information processing system 10 of the exemplary embodiment, the printing records presented to the user UR include a printing record that is obtained from another printer 20 and provided via the network 14. The information processing system 10 of the exemplary embodiment provides the user UR more choices in comparison with the case in which the printing record of only the same printer 20 is presented.

The information processing system 10 of the exemplary embodiment further presents a count at which an operation related to the printing record provided via the network 14 is performed. The information processing system 10 of the exemplary embodiment may thus provide the user UR with an application trend of the printing record.

The information processing system 10 of the exemplary embodiment presents to the user UR the consent confirmation screen 60 that allows the user UR to consent to providing the printing record of the printer 20 via the network 14. The information processing system 10 of the exemplary embodiment may thus urge the user UR to provide the printing record of the printer 20.

When an inquiry about the printing record is received from the user UR using the printer 20, the program 46 of the exemplary embodiment causes the CPU 24A to present to the user UR the printing record available on the printer 20. The program 46 of the exemplary embodiment may present to the user UR of the printer 20 the printing record available on the printer 20.

### First Modification

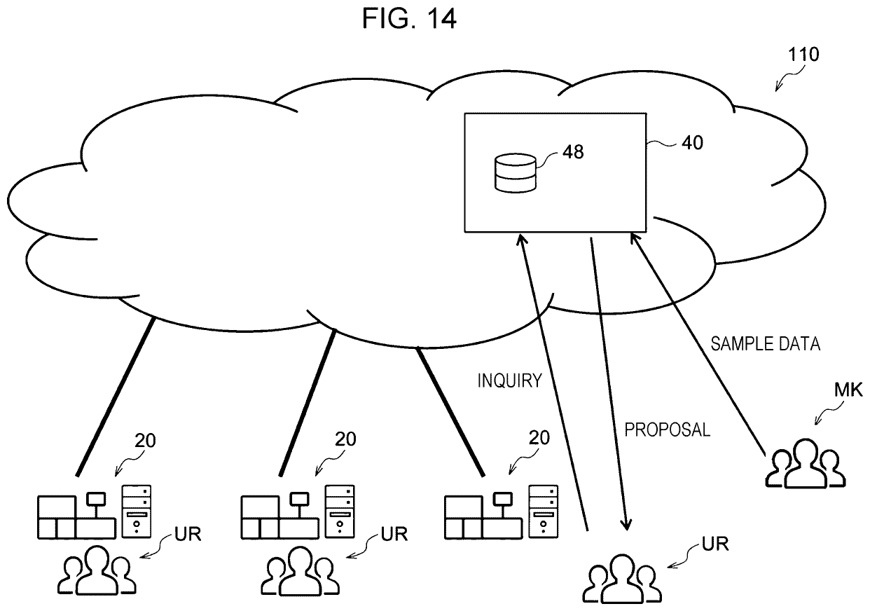

First modification of the exemplary embodiment is described with reference to FIG. 14. In the discussion of the first modification, elements identical to those of the exemplary embodiment are designated with the same reference numerals and the detailed discussion thereof is omitted herein.

In an information processing system 110 of the first modification as illustrated in FIG. 14, a developer MK of the server 40 or the printer 20 may transmit sample data of the printing record to the server 40. The server 40 stores the sample data transmitted from the developer MK in the printing record data 48 in a similar way as described in the exemplary embodiment.

The rest of the configuration remains unchanged from the exemplary embodiment. If in the first modification, the number of users UR using the information processing system 110 is smaller and the number of printing records registered by the users UR using the printers 20 is smaller, a user UR may perform the printing operation using the sample data transmitted by the developer MK.

The first modification may operate as described above and thus may provide the effects described above.

### Second Modification

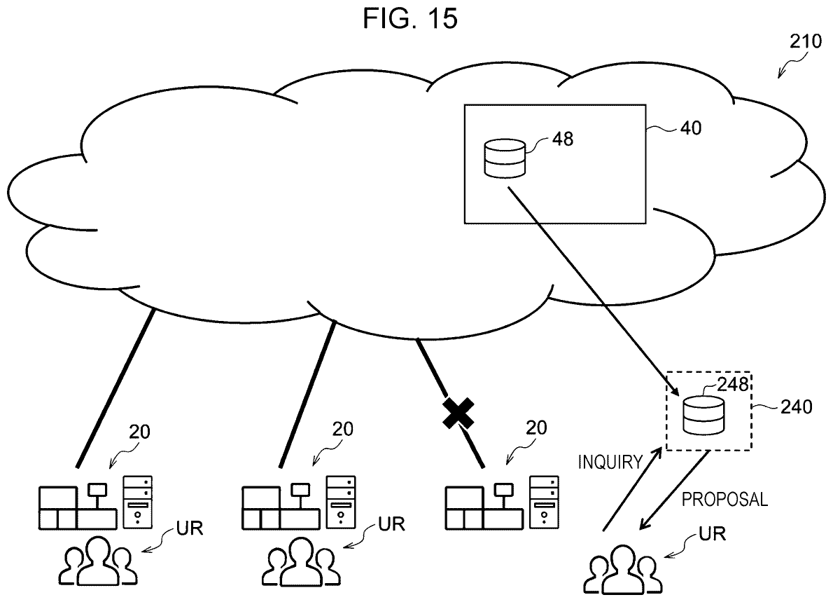

Second modification of the exemplary embodiment is described with reference to FIG. 15. In the second modification, elements identical to those in the exemplary embodiment are designated with the same reference numerals and the discussion thereof is omitted herein.

In an information processing system 210 of the second modification illustrated in FIG. 15, the user UR has a stand-alone server 240 that virtually performs a function equivalent to the function of the server 40 installed over the network 14. The stand-alone server 240 includes printing record data 248 by periodically retrieving the printing record data 48 from the server 40. The stand-alone server 240 is not connected to the network 14 and allows a specific user UR to be connected thereto.

The stand-alone server 240 may retrieve the printing record data 48 in any retrieval method. For example, the user UR or the developer MK responding to a request of the user UR may download the printing record data 48 from the server 40 to a recoding medium and cause the stand-alone server 240 to read the recording medium.

When the printer 20 is disconnected from the network 14 and is thus not connected to the server 40 in the information processing system 210 of the exemplary embodiment as illustrated in FIG. 15, the printer 20 is connected to the stand-alone server 240.

The rest of the configuration remains unchanged from the exemplary embodiment. When the printer 20 makes the inquiry to the stand-alone server 240 in the information processing system 210 of the second modification, the user UR is provided with the printing record.

The second modification also operates as described above and thus may provide the effects described above.

### Other Modifications

As described above, the CPU 44A in the server 40 executes the program 46 such that the printing record on the function available on the printer 20 is presented to the user UR. The information processing system 10 of the exemplary embodiment is not limited to this method. For example, in a configuration where a network attached storage (NAS) is used in place of the server 40 and has the printing record data 48, the printing record data 48 may be transmitted in response to the reception of the inquiry from the printer 20. In other words, the controller 24 in the printer 20 serves as the server 40 in the above discussion. In such a case, the CPU 24A is another example of a “processor” in the exemplary embodiment and the program 26 recorded on the ROM 24C is another example of a “program” in the disclosure.

As described above, the CPU 24A in the printer 20 displays the printing records in the order of similarity to the setting condition of the printer 20. The information processing system 10 of the exemplary embodiment is not limited to this method. Regardless of the setting condition of the printer 20, the CPU 24A in the printer 20 may display the printing records in the order of new to old printing records.

As described above, the CPU 44A in the server 40 rearranges the printing records in accordance with the frequency of use of the function of the printer 20. The information processing system 10 of the exemplary embodiment is not limited to this method. For example, the CPU 44A in the server 40 may display the printing records regardless of the frequency of use.

As described above, the CPU 24A in the printer 20 displays the rating display icon 72 and the operation result display icon 74 together with the printing records. The information processing system 10 of the exemplary embodiment is not limited to this method. The CPU 24A in the printer 20 may not necessarily display the rating display icon 72 and the operation result display icon 74.

As described above, the CPU 44A in the server 40 may make the inquiry of the function of the printer 20 only when the user UR consents to transmitting the printing record to the server 40. The information processing system 10 of the exemplary embodiment is not limited to this method. For example, the CPU 44A in the server 40 may transmit the inquiry of the function of the printer 20 regardless of whether the user UR consents to transmitting the printing record to the server 40. In other words, the consent confirmation screen 60 may not be displayed.

These modifications also operate as described above and thus may provide the effects described above.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))

An information processing system including:
a processor configured to:
   when an inquiry about a function of a manufacturing apparatus is received from a user of the manufacturing apparatus, present, to the user, a production record available on the manufacturing apparatus with respect to the function.
      (((2)))

In the information processing system according to (((1))), the processor is configured to present the production record in an order of similarity to a setting condition of the manufacturing apparatus with respect to the function.

(((3)))

In the information processing system according to (((2))), the processor is configured to determine the order of similarity to the setting condition of the manufacturing apparatus in accordance with a frequency of use of the function of the manufacturing apparatus.

(((4)))

In the information processing system according to (((3))), the processor is configured to weight the frequency of use in accordance with a classification of the function of the manufacturing apparatus.

(((5)))

In the information processing system according to one of (((1))) through (((4))), the production record presented by the processor includes a production record provided by another manufacturing apparatus via a network.

(((6)))

In the information processing system according to (((5))), the processor is configured to present a count at which an operation related to the production record provided via the network is performed.

(((7)))

In the information processing system according to one of (((5))) and (((6))), the processor is configured to present a screen that causes the user to consent to providing via the network the production record which the user has caused the manufacturing apparatus to yield.

(((8)))

A program causing a computer to execute a process including:
when an inquiry about a function of a manufacturing apparatus is received from a user of the manufacturing apparatus, presenting, to the user, a production record available on the manufacturing apparatus with respect to the function.

What is claimed is:

1. An information processing system comprising:
a processor configured to:
when an inquiry about a function of a manufacturing apparatus is received from a user of the manufacturing apparatus, present, to the user, a production record available on the manufacturing apparatus with respect to the function.

2. The information processing system according to claim 1, wherein the processor is configured to present the production record in an order of similarity to a setting condition of the manufacturing apparatus with respect to the function.

3. The information processing system according to claim 2, wherein the processor is configured to determine the order of similarity to the setting condition of the manufacturing apparatus in accordance with a frequency of use of the function of the manufacturing apparatus.

4. The information processing system according to claim 3, wherein the processor is configured to weight the frequency of use in accordance with a classification of the function of the manufacturing apparatus.

5. The information processing system according to claim 1, wherein the production record presented by the processor comprises a production record provided by another manufacturing apparatus via a network.

6. The information processing system according to claim 2, wherein the production record presented by the processor comprises a production record provided by another manufacturing apparatus via a network.

7. The information processing system according to claim 3, wherein the production record presented by the processor comprises a production record provided by another manufacturing apparatus via a network.

8. The information processing system according to claim 4, wherein the production record presented by the processor comprises a production record provided by another manufacturing apparatus via a network.

9. The information processing system according to claim 5, wherein the processor is configured to present a count at which an operation related to the production record provided via the network is performed.

10. The information processing system according to claim 6, wherein the processor is configured to present a count at which an operation related to the production record provided via the network is performed.

11. The information processing system according to claim 7, wherein the processor is configured to present a count at which an operation related to the production record provided via the network is performed.

12. The information processing system according to claim 8, wherein the processor is configured to present a count at which an operation related to the production record provided via the network is performed.

13. The information processing system according to claim 5, wherein the processor is configured to present a screen that causes the user to consent to providing via the network the production record which the user has caused the manufacturing apparatus to yield.

14. The information processing system according to claim 6, wherein the processor is configured to present a screen that causes the user to consent to providing via the network the production record which the user has caused the manufacturing apparatus to yield.

15. The information processing system according to claim 7, wherein the processor is configured to present a screen that causes the user to consent to providing via the network the production record which the user has caused the manufacturing apparatus to yield.

16. The information processing system according to claim 8, wherein the processor is configured to present a screen that causes the user to consent to providing via the network the production record which the user has caused the manufacturing apparatus to yield.

17. A non-transitory computer readable medium storing a program causing a computer to execute a process comprising:
when an inquiry about a function of a manufacturing apparatus is received from a user of the manufacturing apparatus, presenting, to the user, a production record available on the manufacturing apparatus with respect to the function.

18. A method comprising:
when an inquiry about a function of a manufacturing apparatus is received from a user of the manufacturing apparatus, presenting, to the user, a production record available on the manufacturing apparatus with respect to the function.
